(19) United States
(12) Patent Application Publication
(10) Pub. No.: US 2012/0129054 A1
(43) Pub. Date: May 24, 2012

(54) SILICON ANODE LITHIUM-ION BATTERY

(76) Inventors: Haiyan HUANG, Shenzhen (CN); Weiping Liu, Shenzhen (CN)

(21) Appl. No.: 13/301,821

(22) Filed: Nov. 22, 2011

(30) Foreign Application Priority Data
Nov. 24, 2010 (CN) 201010556261.3
Mar. 30, 2011 (CN) 201110078105.5

(51) Int. Cl. H01M 10/056

(52) U.S. Cl. 429/334; 429/342

(57) ABSTRACT

A silicon anode battery comprises: a housing; a battery core comprising a cathode, a silicon anode, and a separator disposed between the cathode and the silicon anode; and an electrolyte comprising at least one lithium salt, a non-aqueous solvent, and an additive, wherein the additive comprises diallyl pyrocarbonate.

### CROSS-REFERENCE TO RELATED APPLICATION

The present application claims priority to and benefits of Chinese Patent Application No. 201010556261.3, filed with the State Intellectual Property Office of the People's Republic of China (SIPO) on Nov. 24, 2010, and Chinese Patent Application No. 201110078105.5, filed with the State Intellectual Property Office of the People's Republic of China (SIPO) on Mar. 30, 2011, the entire contents of both of which are hereby incorporated by reference.

### FIELD

The present disclosure relates to energy storage, and more particularly to a lithium-ion battery having silicon anodes.

### BACKGROUND

Silicon material is widely used as anodes in lithium-ion battery, because it has high lithiation capacities and can be obtained from abundant resources. Nevertheless, Li—Si alloys may undergo large volume changes with reversible battery reactions; after repeated charge/discharge cycles, Li—Si alloys may form metal dusts or cracks, which may cause electrode material to scale off and lose electrical connection, thus reducing battery performance. Furthermore, gases produced by side reactions during charging/discharging may result in swelling of the battery. Therefore, there is a need for silicon anode batteries with high performance.

### SUMMARY

A silicon anode battery is provided, comprising:

a housing;

a battery core, comprising a cathode, a silicon anode, and a separator disposed between the cathode and the silicon anode; and

an electrolyte, comprising at least one lithium salt, a non-aqueous solvent, and an additive, wherein the additive comprises diallyl pyrocarbonate.

In some embodiments, the additive may further comprise at least one of diethyl pyrocarbonate and di-tert butyl pyrocarbonate.

Additional aspects and advantages of the embodiments of the present disclosure will be given in part in the following descriptions, become apparent in part from the following descriptions, or be learned from the practice of the embodiments of the present disclosure.

### DETAILED DESCRIPTION OF THE EMBODIMENTS

It will be appreciated by those of ordinary skill in the art that the disclosure may be embodied in other specific forms without departing from the spirit or essential character thereof. The presently disclosed embodiments are therefore considered in all respects to be illustrative and not restrictive.

In some embodiments, a silicon anode battery comprises:

a housing;

a battery core, comprising a cathode, a silicon anode, and a separator disposed between the cathode and the silicon anode; and

an electrolyte, comprising at least one lithium salt, a non-aqueous solvent, and an additive; wherein the additive comprises diallyl pyrocarbonate.

In one embodiment, diallyl pyrocarbonate has a structure of:

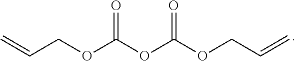

It may promote the reaction between the non-aqueous solvent and Li-ions in the electrolyte to form a stable solid electrolyte interface (SEI) film. The SEI film may prevent or at least reduce reactions of Li—Si alloys with the non-aqueous solvent, and enhance the performance of the battery. Furthermore, the C═C double bond in the allyl group may react with and exhaust water and HF that may be contained in trace amount in the electrolyte, to reduce side reactions and prevent battery swelling.

In some embodiments, the additive may further comprise at least one of diethyl pyrocarbonate and di-tert butyl pyrocarbonate.

In some embodiments, the amount of diallyl pyrocarbonate many range from about 0.1% to about 10% by weight of the electrolyte. The amount of diethyl pyrocarbonate may range from about 0.1% to about 10% by weight of the electrolyte. The amount of di-tert butyl pyrocarbonate may range from about 0.1% to about 10% by weight of the electrolyte.

In some embodiments, the at least one lithium salt may be selected from LiClO₄, LiPF₆, LiBF₄, LiAsF₆, LiSO₃F, and LiCF₃SO₃.

In some embodiments, the non-aqueous solvent may comprise at least one selected from ethylene carbonate (EC), dimethyl carbonate (DMC), ethyl methyl carbonate (EMC), fluoroethylene carbonate (FEC), and diethyl carbonate (DEC).

In some embodiments, the amount of the at least one lithium salt may range from about 1% to about 10% by weight of the electrolyte. The amount of the non-aqueous solvent may range from about 80% to about 98.9% by weight of the electrolyte.

In some embodiments, the silicon anode may be made from materials comprising silicon nanowires or carbon coated silicon nanowires. In some embodiment, the battery disclosed herein may be made in a form of a button battery or a prismatic battery.

### Example 1

### (1) Preparation of an Electrolyte

At room temperature, in a glove box with a water content of less than 5 ppm, a non-aqueous solvent was prepared by mixing EC, DEC and EMC with a weight ratio of about 2:1:3; and then an electrolyte was prepared by mixing LiPF₆, the non-aqueous solvent obtained above, and diallyl pyrocarbonate with a weight ratio of about 8:87:5.

The electrolyte was labeled as S1.

### (2) Preparation of a Silicon Anode Lithium-Ion Battery

LiCoO₂, polyvinylidene fluoride (PVDF), and a conductive additive were mixed and coated onto an aluminum foil to form a cathode plate; silicon nanowires, carboxymethyl cellulose (CMC), and styrene-butadiene rubber (SBR) were mixed and coated onto a cooper foil to form a anode plate; the cathode plate, a polyethylene (PE)/polypropylene (PP) composite polymer separator, the anode plate, and the electrolyte S1 were used to form a silicon anode lithium-ion button battery in a glove box with argon gas through regular assembly processes.

The silicon anode lithium-ion button battery was labeled as A1.

Reference 1

### (1) Preparation of an Electrolyte

The steps were substantially the same as in Example 1, with the exception that: the electrolyte was prepared by mixing LiPF₆ and the non-aqueous solvent obtained above with a weight ratio of about 8:92.

The electrolyte was labeled as DS1.

### (2) Preparation of a Silicon Anode Lithium-Ion Battery

The steps were substantially the same as in Example 1, with the exception that: the cathode plate, the PE/PP composite polymer separator, the anode plate, and the electrolyte DS1 were used to form a silicon anode lithium-ion button battery in a glove box with argon gas through regular assembly processes.

The silicon anode lithium-ion button battery was labeled as DA1.

Reference 2

### (1) Preparation of an Electrolyte

The steps were substantially the same as in Example 1, with the exception that: the electrolyte was prepared by mixing LiPF₆, the non-aqueous solvent obtained above, diethyl pyrocarbonate, and vinylene carbonate with a weight ratio of about 8:89.5:0.5:2.

The electrolyte was labeled as DS2.

### (2) Preparation of a Silicon Anode Lithium-Ion Battery

The steps were substantially the same as in Example 1, with the exception that: the cathode plate, the PE/PP composite polymer separator, the anode plate, and the electrolyte DS2 were used to form a silicon anode lithium-ion button battery in a glove box with argon gas through regular assembly processes.

The silicon anode lithium-ion button battery was labeled as DA2.

### Example 2

### (1) Preparation of an Electrolyte

The steps were substantially the same as in Example 1, with the exception that: the electrolyte was prepared by mixing LiPF₆, the non-aqueous solvent obtained above, and diallyl pyrocarbonate with a weight ratio of about 9:91.9:0.1.

The electrolyte was labeled as S2.

### (2) Preparation of a Silicon Anode Lithium-Ion Battery

The step were substantially the same as in Example 1, with the exception that: the cathode plate, the PE/PP composite polymer separator, the anode plate, and the electrolyte S2 were used to form a silicon anode lithium-ion button battery in a glove box with argon gas through regular assembly processes.

The silicon anode lithium-ion button battery was labeled as A2.

### Example 3

### (1) Preparation of an Electrolyte

The steps were substantially the same as in Example 1, with the exception that: the electrolyte was prepared by mixing LiPF₆, the non-aqueous solvent obtained above, and diallyl pyrocarbonate with a weight ratio of about 4:86:10.

The electrolyte was labeled as S3.

### (2) Preparation of a Silicon Anode Lithium-Ion Battery

The steps were substantially the same as in Example 1, with the exception that: the cathode plate, the PE/PP composite polymer separator, the anode plate, and the electrolyte S2 were used to form a silicon anode lithium-ion button battery in a glove box with argon gas through regular assembly processes.

The silicon anode lithium-ion button battery was labeled as A3.

### Example 4

### (1) Preparation of an Electrolyte

The steps were substantially the same as in Example 1, with the exception that: the electrolyte was prepared by mixing LiPF₆, the non-aqueous solvent obtained above, diallyl pyrocarbonate, diethyl pyrocarbonate, and di-tert butyl pyrocarbonate with a weight ratio of about 5:85:4:3:3.

The electrolyte was labeled as S4.

### (2) Preparation of a Silicon Anode Lithium-Ion Battery

The steps were substantially the same as in Example 1, with the exception that: the cathode plate, the PE/PP composite polymer separator, the anode plate, and the electrolyte S4 were used to form a silicon anode lithium-ion button battery in a glove box with argon gas through regular assembly processes.

The silicon anode lithium-ion button battery was labeled as A4.

### Example 5

Example 5 was prepared substantially the same as Example 1, with the exception that: in step (2), carbon coated silicon nanowires were used, instead of the silicon nanowires, to form the anode plate.

The silicon anode lithium-ion button battery was labeled as A5.

### Example 6

Example 6 was prepared substantially the same as Example 2, with the exception that: in step (2), carbon coated silicon nanowires were used, instead of the silicon nanowires, to form the anode plate.

The silicon anode lithium-ion button battery was labeled as A6.

### Example 7

Example 7 was prepared substantially the same as Example 3, with the exception that: in step (2), carbon coated silicon nanowires were used, instead of the silicon nanowires, to form the anode plate.

The silicon anode lithium-ion button battery was labeled as A7.

### Example 8

Example 8 was prepared substantially the same as Example 4, with the exception that: in step (2), carbon coated silicon nanowires were used, instead of the silicon nanowires, to form the anode plate.

The silicon anode lithium-ion button battery was labeled as A8.

Reference 3

Reference 3 was prepared substantially the same as Reference 1, with the exception that: in step (2), carbon coated silicon nanowires were used, instead of the silicon nanowires, to form the anode plate.

The silicon anode lithium-ion button battery was labeled as DA3.

Reference 4

Reference 4 was prepared substantially the same as Reference 2, with the exception that: in step (2), carbon coated silicon nanowires were used, instead of the silicon nanowires, to form the anode plate.

The silicon anode lithium-ion button battery was labeled as DA4.

### Example 9

Example 9 was prepared substantially the same as Example 1, with the exceptions that: in step (2), carbon coated silicon nanowires were used, instead of the silicon nanowires, to form the anode plate; and that a silicon anode lithium-ion prismatic battery, instead of a button battery, was prepared with an aluminum housing.

The silicon anode lithium-ion prismatic battery was labeled as A9.

### Example 10

Example 10 was prepared substantially the same as Example 2, with the exceptions that: in step (2), carbon coated silicon nanowires were used, instead of the silicon nanowires, to form the anode plate; and that a silicon anode lithium-ion prismatic battery, instead of a button battery, was prepared with an aluminum housing.

The silicon anode lithium-ion prismatic battery was labeled as A10.

### Example 11

Example 11 was prepared substantially the same as Example 3, with the exceptions that: in step (2), carbon coated silicon nanowires were used, instead of the silicon nanowires, to form the anode plate; and that a silicon anode lithium-ion prismatic battery, instead of a button battery, was prepared with an aluminum housing.

The silicon anode lithium-ion prismatic battery was labeled as A11.

### Example 12

Example 12 was prepared substantially the same as Example 4, with the exceptions that: in step (2), carbon coated silicon nanowires were used instead of the silicon nanowires, to form the anode plate; and that a silicon anode lithium-ion prismatic battery, instead of a button battery, was prepared with an aluminum housing.

The silicon anode lithium-ion prismatic battery was labeled as A12.

Reference 5

Reference 5 was substantially the same as Reference 1, with the exceptions that: in step (2), carbon coated silicon nanowires were used, instead of the silicon nanowires, to form the anode plate; and that a silicon anode lithium-ion prismatic battery, instead of a button battery, was prepared with an aluminum housing.

The silicon anode lithium-ion prismatic battery was labeled as DA5.

Reference 6

Reference 6 was prepared substantially the same as Reference 2, with the exceptions that: in step (2), carbon coated silicon nanowires were used, instead of the silicon nanowires, to form the anode plate; and that a silicon anode lithium-ion prismatic battery, instead of a button battery, was prepared with an aluminum housing.

The silicon anode lithium-ion prismatic battery was labeled as DA6.

Testing

The silicon anode lithium-ion button batteries A1 to A8 and DA1 to DA4 were charged and discharged at a current of about 0.1 mA and a voltage of about 0.005 V to about 1.5 V. The results were listed in Table 1.

Discharge efficiency=charge capacity/discharge capacity×100%.

TABLE 1

| | Charge | Discharge | Discharge |
|---|---|---|---|
| Batteries | capacity/mAh | capacity/mAh | efficiency/% |
| A1 | 3804 | 3215 | 84.52 |
| A2 | 3786 | 3106 | 82.04 |
| A3 | 3874 | 3225 | 83.25 |
| A4 | 3904 | 3279 | 83.99 |
| DA1 | 3386 | 847 | 25.02 |
| DA2 | 3593 | 1693 | 47.12 |
| A5 | 629 | 587 | 93.32 |
| A6 | 632 | 582 | 92.09 |
| A7 | 619 | 577 | 93.22 |
| A8 | 640 | 599 | 93.59 |
| DA3 | 558 | 261 | 46.77 |
| DA4 | 571 | 417 | 73.03 |

The silicon anode lithium-ion prismatic batteries A9 to A12, DA5 and DA6 were charged and discharged at a current of about 200 mA and a voltage of about 3.0 V to about 4.2 V, and repeated for 100 cycles. The results were listed in Table 2.

Remaining efficiency=remaining discharge capacity after 100 cycles/primal discharge capacity×100%.

TABLE 2

| | | | | | | Battery |
|---|---|---|---|---|---|---|
| | | | | | | thickness |
| | Primal charge | Primal discharge | Discharge | Remaining | Primal battery | after 100 |
| Batteries | capacity/mAh | capacity/mAh | efficiency/% | efficiency/% | thickness/mm | cycles/ mm |
| A9 | 984 | 980 | 99.59 | 62.7 | 5.3 | 6.2 |
| A10 | 966 | 958 | 99.17 | 61.2 | 5.6 | 6.2 |
| A11 | 974 | 969 | 99.49 | 60.7 | 5.4 | 6.1 |
| A12 | 979 | 971 | 99.18 | 61.8 | 5.8 | 6.3 |
| DA5 | 935 | 893 | 95.51 | 35.3 | 6.5 | 9.3 |
| DA6 | 954 | 930 | 97.48 | 46.7 | 6.1 | 7.8 |

As shown in Table 1, the silicon anode lithium-ion button batteries A1 to A8 have better charge and discharge performance. And as shown in Table 2, the silicon anode lithium-ion prismatic batteries A9 to A12 have better charge and discharge performance, higher remaining capacity, and less thickness changes.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure may be made without departing from the scope or spirit of the present disclosure. Therefore, it is to be understood that the disclosure is not to be limited to the specific embodiments disclosed and that modifications and other embodiments are intended to be included within the scope of the appended claims.

What is claimed is:

1. A silicon anode battery, comprising:
a housing;
a battery core, comprising a cathode, a silicon anode, and a separator disposed between the cathode and the silicon anode; and
an electrolyte, comprising at least one lithium salt, a non-aqueous solvent, and an additive, wherein the additive comprises diallyl pyrocarbonate.

2. The silicon anode battery of claim 1, wherein the amount of diallyl pyrocarbonate ranges from about 0.1% to about 10% by weight of the electrolyte.

3. The silicon anode battery of claim 1, wherein the amount of the at least one lithium salt ranges from about 1% to about 10% by weight of the electrolyte.

4. The silicon anode battery of claim 1, wherein the amount of the non-aqueous solvent ranges from about 80% to about 98.9% by weight of the electrolyte.

5. The silicon anode battery of claim 1, wherein the at least one lithium salt is selected from LiCl₄, LiPF₆, LiBF₄, LiAsF₆, LiSO₃F, and LiCF₃SO₃.

6. The silicon anode battery of claim 1, wherein the non-aqueous solvent comprises at least one selected from ethylene carbonate, dimethyl carbonate, ethyl methyl carbonate, fluoroethylene carbonate, and diethyl carbonate.

7. The silicon anode battery of claim 1, wherein the additive further comprises at least one of diethyl pyrocarbonate and di-tert butyl pyrocarbonate.

8. The silicon anode battery of claim 7, wherein the amount of diethyl pyrocarbonate ranges from about 0.1% to about 10% by weight of the electrolyte, and the amount of di-tert butyl pyrocarbonate ranges from about 0.1% to about 10% by weight of the electrolyte.

9. The silicon anode battery of claim 1, wherein the silicon anode is made from materials comprising silicon nanowires or carbon coated silicon nanowires.

10. The silicon anode battery of claim 1, wherein the battery is made in a form of a button battery or a prismatic battery
